(19) United States
(12) Patent Application Publication
(10) Pub. No.: US 2017/0361876 A1
(43) Pub. Date: Dec. 21, 2017

(54) VEHICLE STYLING BAR

(71) Applicant: CHIH-YUAN YANG, Tainan (TW)

(72) Inventor: CHIH-YUAN YANG, Tainan (TW)

(73) Assignee: TAYIH LUN AN CO., LTD., Tainan (TW)

(21) Appl. No.: 15/185,038

(22) Filed: Jun. 17, 2016

(51) Int. Cl. B62D 29/04; B62D 25/06

(52) U.S. Cl. CPC B62D 29/043; B62D 25/06

(57) ABSTRACT

A vehicle styling bar is provided for a truck including a cab and an open cargo bed. The vehicle styling bar is made of plastic and formed into an integral U-shaped hollow piece adapted to be installed widthwise across the cargo bed, immediately next to the cab for blocking sunlight that may pass through a rear window of the cab. The vehicle styling bar has a reduced weight and can be installed more easily than existing vehicle styling bars.

### BACKGROUND OF THE INVENTION

### 1. Field of the Invention

This invention relates to a vehicle styling bar, which is made of plastic and formed into an integral U-shaped hollow piece, which has a reduced weight and can be installed onto a truck more easily.

### 2. Description of the Prior Art

Commonly, a typical pickup truck is consisted of a cab able to accommodate seats of passengers and a cargo bed able to load goods. A rear window is located at the rear wall of the cab, adjacent to the cargo bed; however, sunlight can directly project into the cab through the rear window, causing the passengers in the cab to feel hot or illness. Therefore, referring to FIGS. 1 through 3, a vehicle styling bar 1, which is comprised of a main body 10 and two lateral holders 11, can be installed onto a pickup truck. The body 10 and the lateral holders 11 are firmly assembled by connecting members 12 and connecting plates 13 and their associated fasteners 120, 130. Also, decorative plates 14 are used to conceal the connecting plates 13. The styling bar 1 can be installed on the cargo bed A1 of the pickup truck A by inserting fasteners (not shown) through the installing sides 110 at the bottoms of the lateral holders 11 of the styling bar 1. The styling bar 1 can block the sunlight projecting through the rear window A2 of the pickup truck A. However, the structure of the styling bar 1 is complicated and expensive and takes a lot of time to be installed onto a truck.

### SUMMARY OF THE INVENTION

One object of the present invention is to provide a vehicle styling bar, which is made of plastic and formed into an integral U-shaped hollow piece to reduce its weight and to facilitate installation.

Preferably, the vehicle styling bar is made of ABS material.

### BRIEF DESCRIPTION OF DRAWINGS

This invention will be better understood by referring to the accompanying drawings, wherein:

FIG. 1 is an exploded perspective view of a conventional vehicle styling bar;

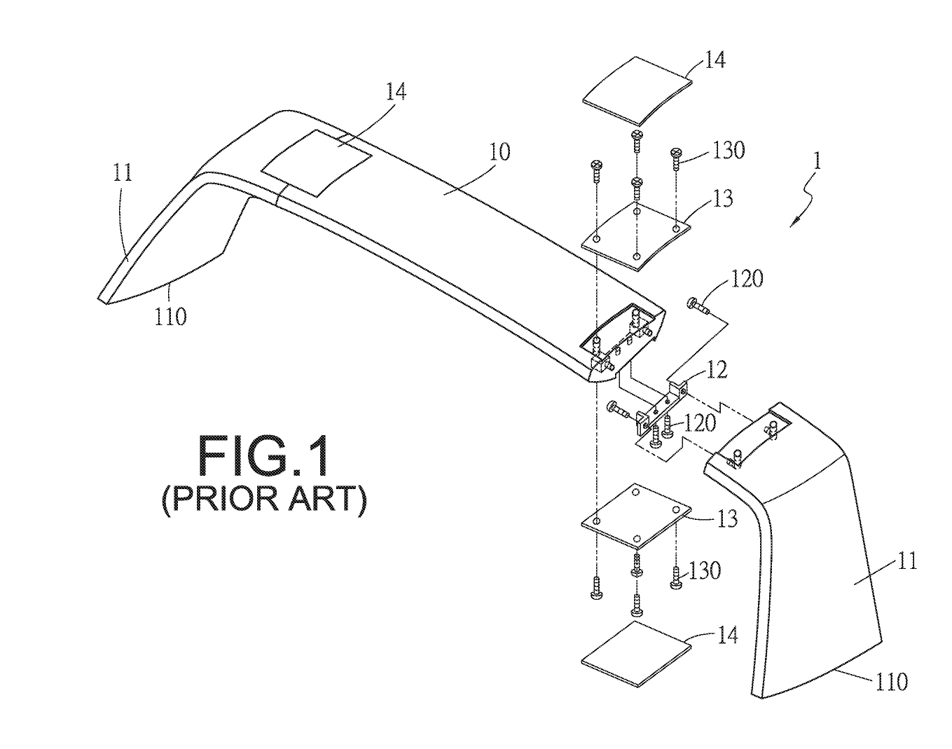

FIG. 2 is a partial, enlarged cross-sectional view of the conventional vehicle styling bar;

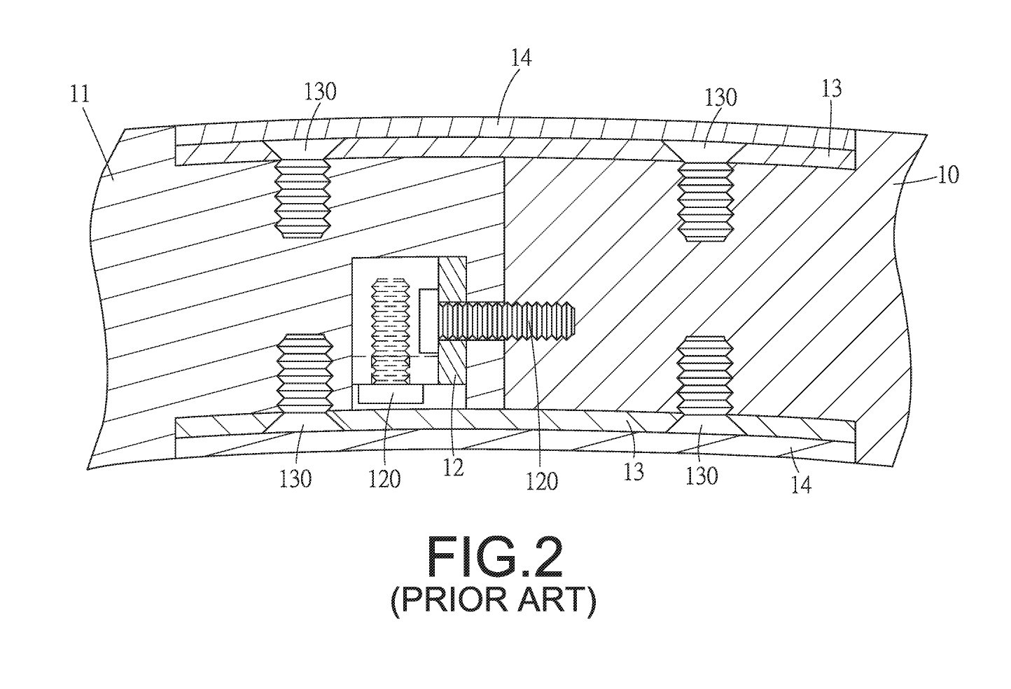

FIG. 3 is a schematic view showing the conventional vehicle styling bar installed on the cargo bed of a pickup truck;

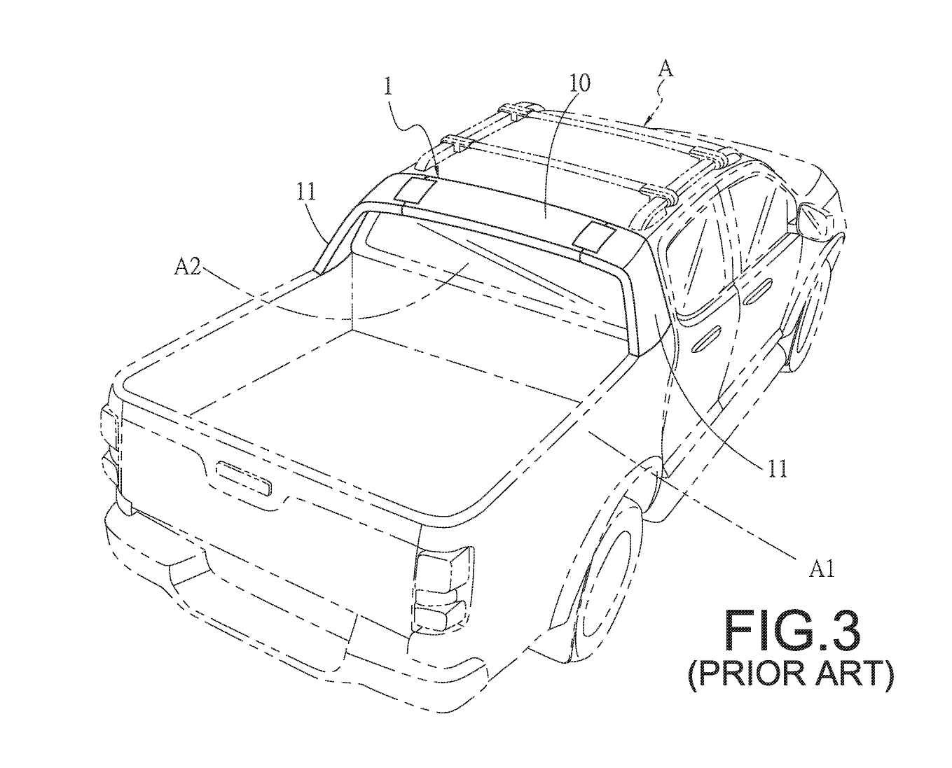

FIG. 4 is a perspective view of a vehicle styling bar according to one embodiment the present invention;

FIG. 5 is a partial cross sectional view of a vehicle styling bar of the present invention;

FIG. 6 is a cross-sectional view taken along line A-A of FIG. 5;

FIG. 7 is a schematic view showing the vehicle styling bar installed on the cargo bed of a pickup truck; and

FIG. 8 is a schematic view showing the vehicle styling bar installed on the cargo bed of a pickup truck provided with two rails.

### DETAILED DESCRIPTION OF THE PREFERRED EMBODIMENTS

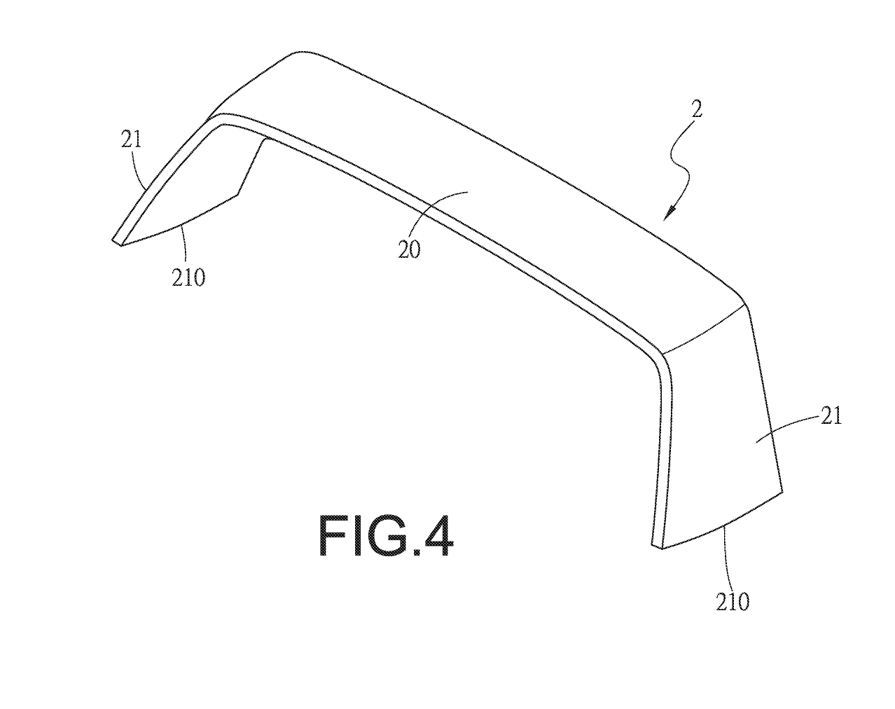

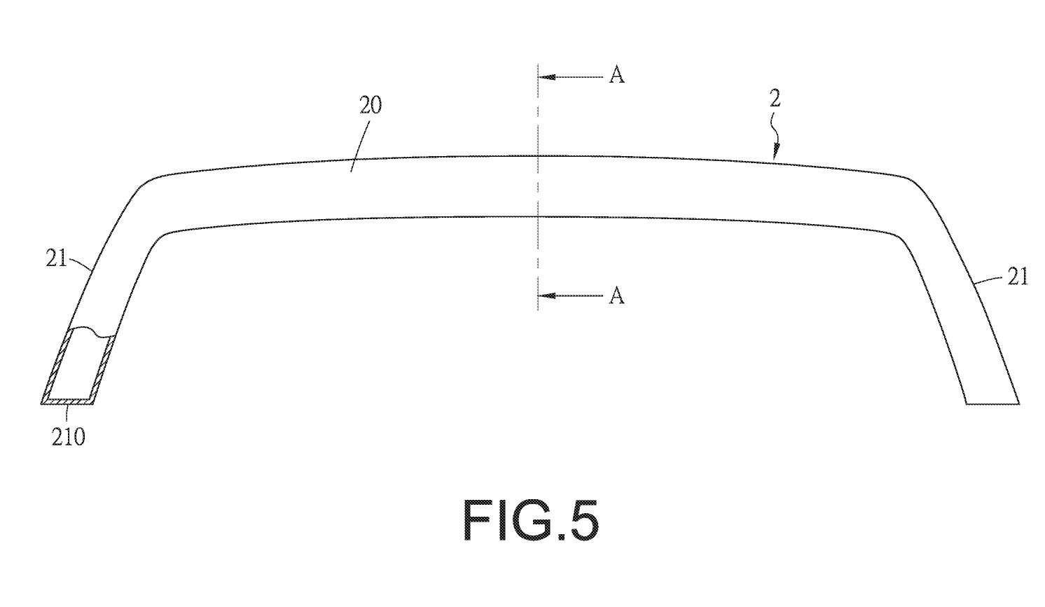

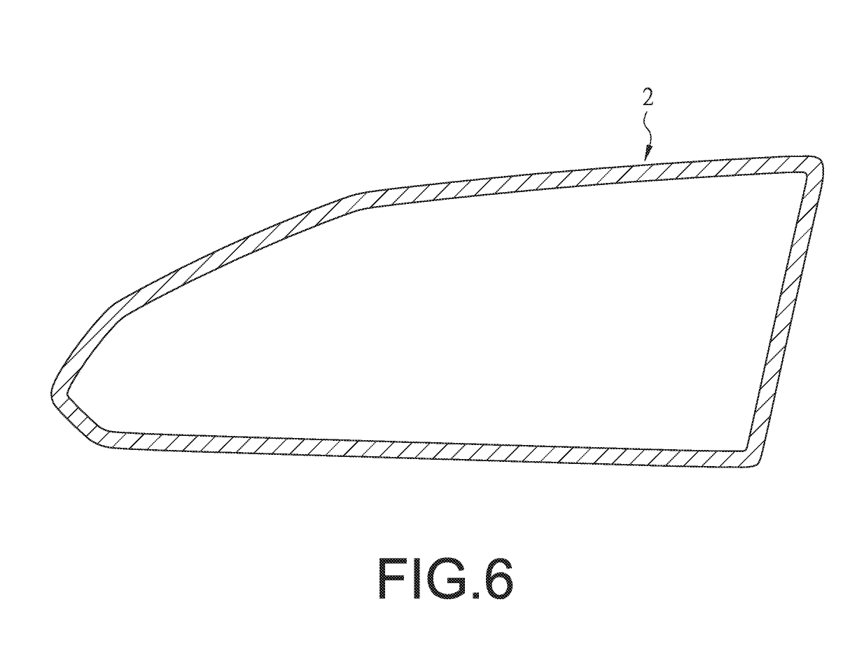

Referring to FIGS. 4, 5 and 6, a vehicle styling bar 2 according to one embodiment of the present invention is shown. The vehicle styling bar 2 is made of plastic, such as ABS (acrylonitrile butadiene styrene), and formed into an interal, substantially U-shaped, hollow piece, which has a main portion 20 and two lateral portions 21 each having an installing face 210 at its bottom. Preferably, the hollow piece is manufactured by blow molding.

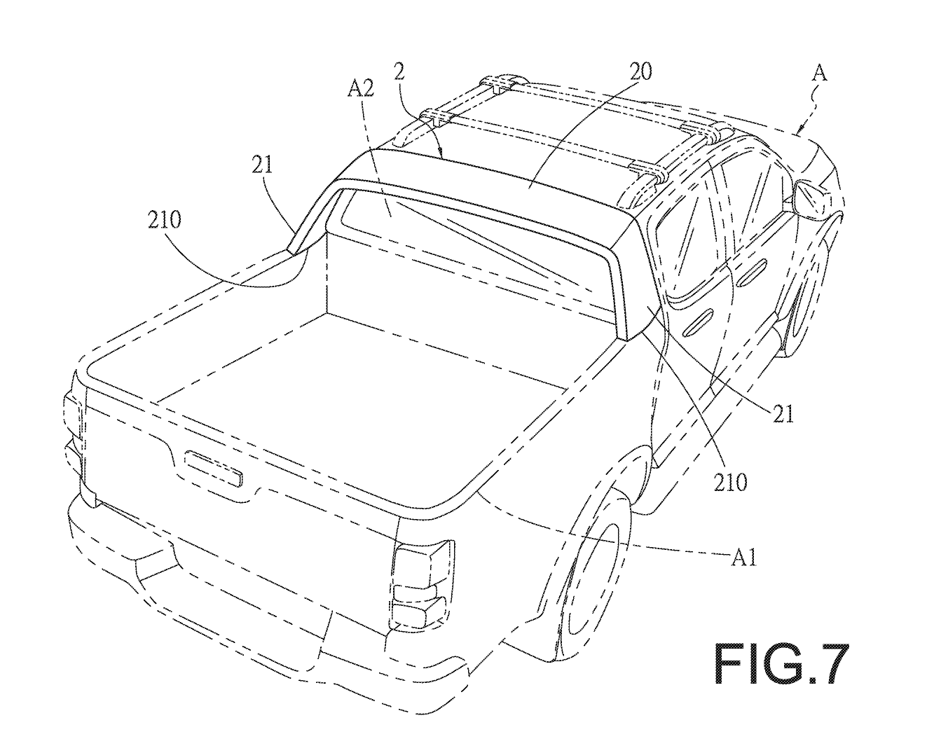

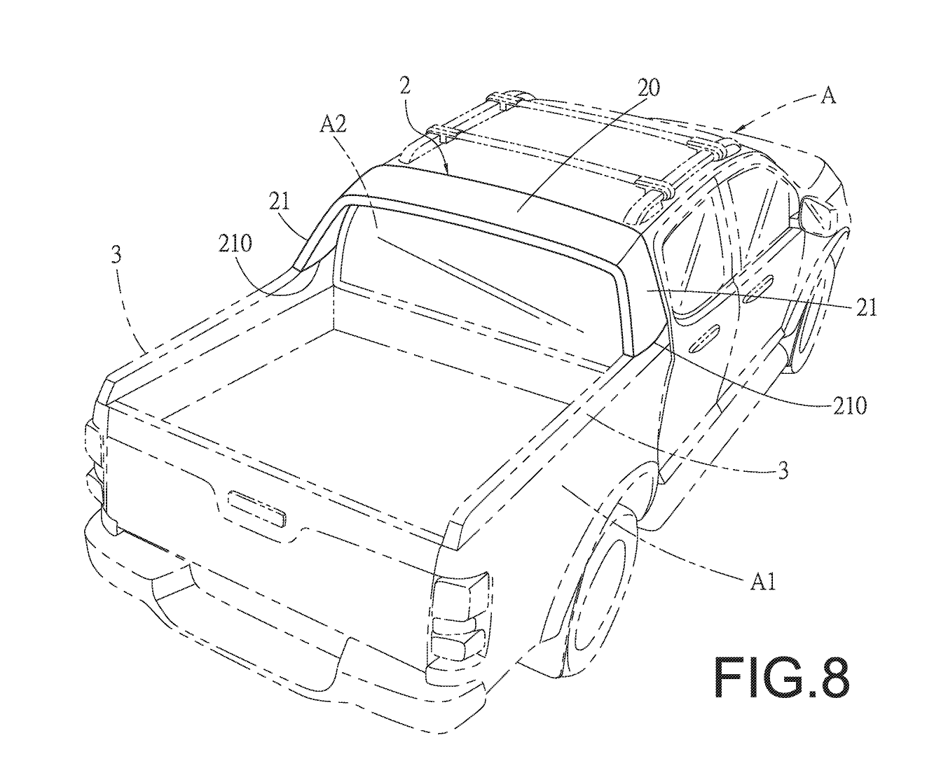

In use, as shown in FIG. 7, the vehicle styling bar 2 can be installed widthwise across the cargo bed (A1) of a pickup truck (A) through the installing faces 210 and the associated fasteners (not shown). In FIG. 8, the pickup truck (A) is provided with two rails 3 to increase the height of the lateral sides of the cargo bed (A1)

Therefore, the vehicle styling bar 2 can block sunlight projecting into the cab of the pickup truck (A) by way of the rear window (A2). Since the vehicle styling bar 2 is made of plastic and formed into an integral hollow piece, its weight and cost can be reduced, and it can be installed onto a vehicle more easily. Furthermore, the appearance of a vehicle installed with the styling bar of the present invention can be improved.

While the preferred embodiments of the invention have been described above, it will be recognized and understood that various modifications may be made therein and that the claims are intended to cover all such modifications that may fall within the spirit and scope of the invention.

1-2. (canceled)

3. A vehicle styling bar for a truck including a cab and an open cargo bed, the vehicle styling bar being made of plastic and formed into an integral U-shaped hollow piece adapted to be installed widthwise across the cargo bed, immediately next to the cab for blocking sunlight that may pass through a rear window of the cab.

4. The vehicle styling bar of claim 3, which is made of ABS material.

5. The vehicle styling bar of claim 4, which is formed by blow molding.
